(19) United States
(12) Patent Application Publication
(10) Pub. No.: US 2012/0036166 A1
(43) Pub. Date: Feb. 9, 2012

(54) EFFECTIVE DATING FOR TABLE OR RELATIONSHIP MODIFICATIONS

(75) Inventors: James Z. Qiu, San Ramon, CA (US); Paul Blokhin, Union City, CA (US); Jie Liu, Foster City, CA (US); Masayuki Karahashi, San Mateo, CA (US)

(73) Assignee: Oracle International Corporation, Redwood Shores, CA (US)

(21) Appl. No.: 12/852,234

(22) Filed: Aug. 6, 2010

(51) Int. Cl. G06F 17/30

(52) U.S. Cl. 707/803; 707/E17.005

(57) ABSTRACT

A method of application phased upgrade and phased user migration. In one embodiment, in one embodiment a first version of an application generates a first SQL insert statement, wherein the first SQL insert statement comprises a first table name, a first field name, and a first value. A second version of an application generates a second SQL insert statement, wherein the second SQL insert statement comprises the first table name, the first field name, and a second value. A database system inserts a first record into a first table in response to the database system receiving the first SQL insert statement. The database system inserts a second record into the first table via a view in response to the database system receiving the second SQL insert statement. The first record comprises distinct first and second fields corresponding to the first name and a second field name, respectively. The first field stores the first value. The second record comprises distinct first and second fields corresponding to the first and second field names, respectively. The second field of the second record stores the second value.

### BACKGROUND OF THE INVENTION

Enterprise applications provide business logic functionality for enterprises, typically commercial organizations, which aims to improve the enterprises' productivity and efficiency. Services provided by enterprise applications are typically business-oriented such as online shopping, online payment processing, automated billing systems, content management, customer relationship management, etc.

Enterprise applications evolve over time to accommodate new functionality. New versions of enterprise applications are typically released by developers every 1-2 years. When released, business customers upgrade their integrated computer-based systems by replacing an old version of the enterprise application with a new version. In addition, business customers are often required to modify the underlying database to accommodate the new version.

Enterprise applications such as customer relation management (CRM) applications manage information stored in relational databases. The present invention will be described with reference to CRM applications managing information stored in relational databases of any kind, it being understood the present invention should not be limited thereto. In a relational database, information is typically stored in database objects such as tables, which can be seen as two-dimensional structures of columns and rows. In more traditional computer terminology, the columns are called fields and the rows are called records. Each record of a table represents one object (e.g., a person), event, or relationship.

Tables in a relational database may contain hundreds or thousands of records. A field in a record contains one value of particular type of information. A field should not contain one type of information for one record in a table and another type of information for another record in the same table. Each field has a name and an information type. Essentially, there are three main information types: text, numbers, and dates. Some fields allow nulls, which are unknown values. Other fields do not allow them. If a field does not allow nulls, then a value is usually required in the field for every record of the table.

Each field has a position within the table. That is, fields are an ordered set. This contrasts with records, which have no fixed order. Information about the fields—their names, information types, positions, and whether they accept nulls—is all considered to be part of the definition of the table itself and is part of a database schema definition. In contrast, information about the records is considered to be part of the data and not part of the definition of the table.

Primary and foreign keys are important components in relational database tables. Most tables in relational databases contain a primary key that uniquely identifies each row or record. Each row must have its own identity, so no two rows are allowed to have the same primary key. Foreign keys are contained in a column of a child table and reference primary keys in a parent table. A primary key in a parent table can be referenced in many child table records.

Structured query language (SQL) is a computer language that allows CRM applications to access relational databases. The select statement or command can used to retrieve information from a table. The basic select statement has four clauses that include: the select clause, which identifies which columns are sought; the from clause, which identifies a table that contains the data sought; the where clause, which identifies the rows sought; and the order by clause, which identifies how to sort the final result. The results of a select statement are typically returned in a result table, which has columns and rows, and which can be displayed on a monitor of, for example, a client computer system that is in data communication with a database via a CRM application.

Tables can be modified by adding new records, updating values in one or more fields of existing records, or deleting records entirely. Records can be added to a table using an insert statement or command, which typically begins with insert into, followed by the name of the table. The insert statement typically has the word values followed by a list of values to be inserted into respective fields of the new record. The value put into any field of a record must always match the information type of that field: text, number, or date. Values within one or more columns of a table can be modified using the update statement. The syntax of update statements is typically easier to read and work with when compared to the insert statement. In update statements, the name of the field is aligned with its new value. A record in a table may be removed using the delete statement or command.

A database schema is a collection of database objects (e.g., tables) associated with one schema owner. A relational database may have more than one schema. CRM application can connect to schemas using distinct schema owner qualifiers. Once a connection is made, the CRM application can manage data within a schema using various SQL statements such as update, insert, delete, etc. A database cannot be queried without an open and available connection to it. Connections are built by supplying an underlying driver or provider with a connection stream that specifies information about a data source (e.g., a schema) and the needs of connecting to it. A connection stream is a way of addressing a specific schema as well as user authentication credentials. CRM applications generate SQL statements according to database schema definitions. A schema definition can be simply described as the “layout” of a database or the blueprint that outlines the way data is organized into tables.

In some relational databases, such as certain Oracle databases, schemas have owners, and table names are always unique in a database because the schema owner is a part of the table name. When a schema owner accesses a table that she owns, the user does not have to refer to the schema name. For instance, a user could refer to her own table in a SQL statement as either one of the following: CONTACT_TBL, or S1.CONTACT_TBL. If another user were to query the owner's tables, the user would have to specify the schema, as follows: S1.CONTACT_TBL. However, it should be understood that the present invention should not be limited to use with Oracle relational databases.

Schemas may include synonyms and views. A synonym is merely another name for a table or a view. Synonyms are usually created so a user can avoid having to qualify another user's table or view to access the table or view. A view is a logical table as opposed to a physical table stored in a database system. That is, a view looks like a table and acts like a table, but it does not require physical storage. A view is actually a composition of a table in the form of a predefined query, which is stored in the database. For example, a view can be created that contains only selected columns from a table, instead of all columns from the table. A view can be created from one or more tables. A view can project a column name of an underlying table as a different name.

Views are created using the create view statement or command. Views can be created from a single table, multiple tables, or another view. When a view is created, a select statement is actually run against the database, which defines the view. The select statement used to define the view might simply contain column names from a table and/or it may rename columns (e.g., Phone_Number as Phone_R where Phone_R is the name of an existing column) of a table. The select statement can be more explicitly written using various functions and calculations to manipulate or summarize the data that the user sees.

A view is considered a database object, although a view takes up no storage space on its own. A view is used in the same manner as a table is used in a database, meaning that data can be selected from a view as it is from a table. Views can be updateable. Tables underlying a view can be manipulated through the view using SQL statements such as update or insert. The same rules that apply to the update also apply to insert.

### BRIEF DESCRIPTION OF THE DRAWINGS

The present invention may be better understood, and its numerous objects, features, and advantages made apparent to those skilled in the art by referencing the accompanying drawings.

FIG. 1 graphically illustrates an example table employed in a relational database system.

FIG. 2 graphically illustrates another example table employed in a relational database system.

FIG. 3 graphically illustrates a system for upgrading a CRM application.

FIG. 4 graphically illustrates another system for upgrading a CRM application.

FIG. 5A-5F example table employed in the relational database system of FIG. 4.

FIG. 6 is a block diagram of an example computer system that may be employed in the system of FIG. 3 or 4.

The use of the same reference symbols in different drawings indicates similar or identical items.

### DETAILED DESCRIPTION

CRM applications evolve over time to include new functions or features. An old version of a CRM application can be modified, for example, by modifying underlying business rules, to create a new version of the CRM application. Rules of the new CRM application, however, may create incompatibilities between the new CRM and the database schema of the old version. In this situation, a new database schema should be created to accommodate rules of the new CRM application. Unfortunately the new schema may be incompatible with the business rules of the old CRM application.

A new schema definition can be created by modifying the old database schema definition. More particularly, tables specific to the new CRM may be added. These new tables will be referred herein as version specific tables. Some existing tables may be dropped. Other existing tables can be modified to create corresponding tables in the new schema. To illustrate, columns in an existing table may be replaced, or columns may be added. Constraints can be added or changed (default value, nullability) to existing columns. The data type or length can be changed on existing columns. Value format rules can be changed on existing columns (e.g. 510-441-0000 vs 5104410000). Unique constraints can be re-defined or created on existing tables.

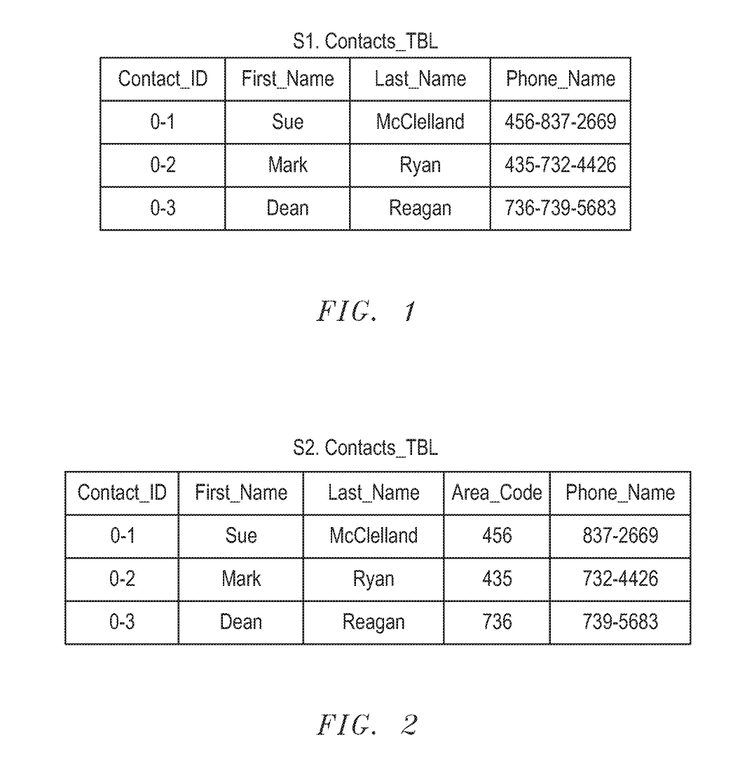

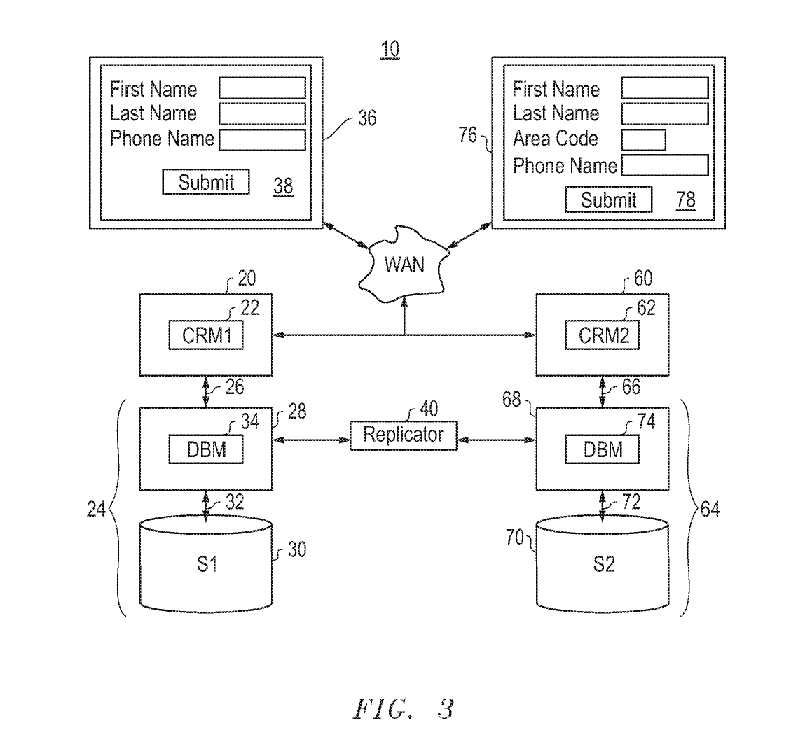

Some tables in the new schema, (i.e, corresponding tables that were created by modifying tables of the old schema) may not be compatible with the old CRM application. A table of the new schema may have been created by replacing and/or adding new columns to an existing table of the old schema, and this table may not be compatible with the rules of the old CRM, and some of the columns in existing table of the old schema may not be compatible with the rules of the new CRM. To illustrate, FIG. 1 contains a graphical representation of a physical table CONTACTS_TBL of an old schema, which is identified by owner S1. The CONTACTS_TBL table of FIG. 1 includes four fields named Contact_ID, First_Name, Last_Name and Phone_Number. While connected to schema S1, the old CRM application can access the CONTACTS_TBL table using various SQL statements such as select, insert, update, etc. FIG. 2 contains a graphical representation of a corresponding table CONTACTS_TBL for a new schema S2, which includes many of the same fields that are contained within the corresponding CONTACTS_TBL table of S1. However, differences exist between these two tables. For example, the CONTACTS_TBL table of S2 includes an additional field named Area_Code.

While records in these two tables contain the same information, the information is not arranged in a consistent manner. The Phone_Number field of the CONTACTS_TBL table of S1 includes a full phone number including the three digit area code. In S2, the area code and base seven digit phone number are separated and stored in Area_Code and Phone_Number, respectively. Because of the differences, CONTACTS_ID of S2 may not be in compliance with business rules defined in the old CRM application that require, for example, storing a phone number (including area code) into the Phone_Number field of a record after a user enters the phone number into a client interface field, and the CONTACTS_TBL table of S1 may lack compliance with the business rules of the new CRM that require, for example, storing an area code and base phone number into the Area_Code and Phone_Number fields, respectively, of a record after a user enters the area code and base phone number into a respective client interface fields. In other words, the new CRM application is incapable of inserting a new record into or updating an existing record of FIG. 1's CONTACTS_TBL table because of the incompatibility between S1's definition and the new business rules. Likewise, the old CRM application would be incapable of inserting a new record into or updating an existing record of FIG. 2's CONTACTS_TBL because the incompatibility between S2's definition and the old business rules.

CRM developers release new versions of CRM applications every one to two years. It is a common practice for customers to implement new versions of CRM applications as an “all-at-once upgrade.” As part of this process, data from the old schema is migrated to the new schema. Once the data migration is complete, users are migrated to the new CRM and the old CRM is retired. This all-at-once upgrade approach may require a substantial down time of the database system to enable the full migration of existing data from the old schema to the new schema. Further, the all-at-once upgrade practice does not provide a flexible and easy roll back strategy.

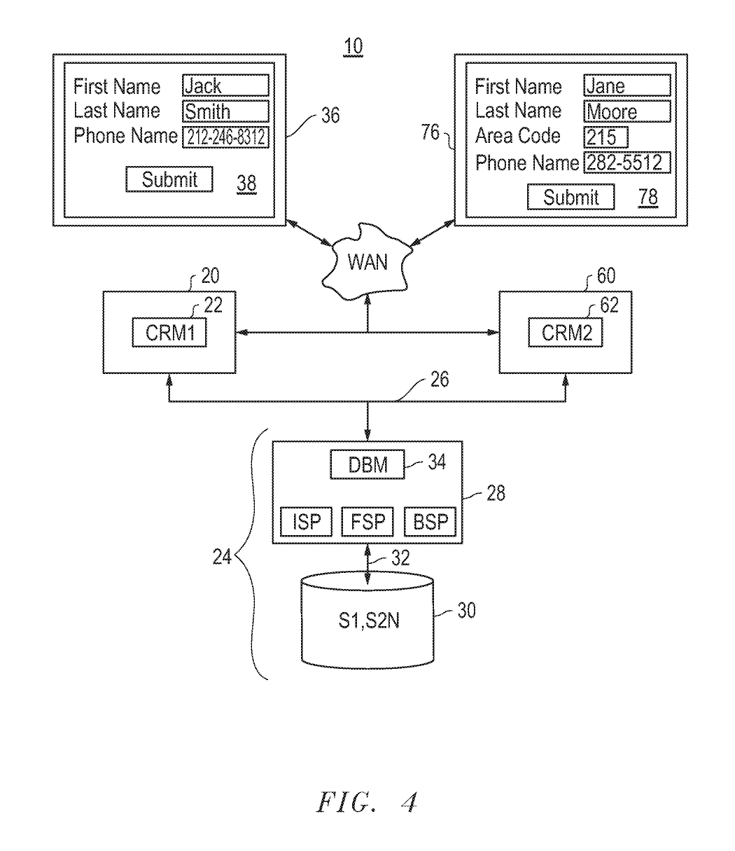

Many customers are reluctant to implement all-at-once upgrades due to the high cost and risk associated with it. Customers with high demand of 24/7 operations, for example, may be unable to upgrade at all because the all-at-once upgrade process is disruptive to their business. Rather than the all-at-once approach to upgrading a system, an alternative is to concurrently run the old and new versions of the CRM until all the users have migrated from the old version to the new version. This alternative approach requires concurrent implementation of the old and new database schemas along with continuous synchronization therebetween until the old CRM is retired. FIG. 3 illustrates in block diagram form, relevant components of a system 10 that implements this upgrade approach. As will be more fully described below, system 10 employs a replicator to synchronize the databases of the old and new versions until all users have migrated.

System 10 includes computer systems (e.g., servers) 20 and 60, which implement distinct versions of a CRM application. In one embodiment, CRM applications may take form in computer executable instructions that are stored within a memory. Server 20 implements an old version of a CRM (hereinafter CRM1) on one or more processors thereof, while server 60 implements the new version of a CRM (hereinafter CRM2) on one or more processors thereof.

CRM1 is in data communication with relational database system 24 via communication link 26, while CRM2 is in data communication with relational database system 64 via communication link 66. The communication links 26 and 66 are configured to transmit SQL statements for implementation by the database systems. Further, the communication links 26 and 66 are configured to transmit results of SQL statement implementation to CRM1 and CRM2, respectively.

Database system 24 includes a computer system (e.g., server) 28 in data communication with a storage subsystem via communication link 32. In one embodiment, communication link 32 may take form in a storage area network (SAN) that includes multiple components, such as bridges, routers, switches, etc., which collectively is configured to transmit transactions between database server 28 and storage subsystem 30. Server 28 implements a relational database manager (DBM) 34. In one embodiment, DBM 34 may take form in software instructions executing on one or more processors of database server 28. DBM 34 is responsible for implementing SQL statements received from CRM2 via communication link 26, and for returning results of implementing these SQL statements. In one embodiment, storage subsystem 30 may take form in one or more memory devices (e.g., disk arrays), which can store tables accessible by CRM1 via DBM 34 and an S1 qualified connection.

Database system 64 also includes a computer system (e.g., server) 68 in data communication with a storage subsystem via communication link 72. In one embodiment, communication link 72 may take form in a storage area network (SAN), which is configured to transmit transactions between database server 68 and storage subsystem 70. Database server 68 implements a relational database manager (DBM) 74 that may take form in software instructions executing on one or more processors. DBM 74 is responsible for implementing SQL statements received from CRM2 via communication link 66, and for returning results of implementing these SQL statements. In one embodiment, storage subsystem 70 may take form in one or more memory devices (e.g., disk arrays), which can store tables accessible by CRM2 via DBM 74 and an S2 qualified connection.

CRM1 connects to the tables of schema S1, which may include the CONTACTS_TBL table illustrated in FIG. 1. CRM1 is also in data communication with one or more client computer systems 36 via a wide area network (WAN) such as the Internet. CRM1 is configured to receive transactions from client computer system 36. These transactions may include requests that initiate access of a table in order to, for example, insert a new record with values entered by a user into an interface implemented on client 36. FIG. 3 graphically illustrates a portion of one user interface 38, which includes a pair of fields for entering contact data and a submit button. The example array user interface 38 may be used to initiate the creation of a new record within CONTACTS_TBL of FIG. 1.

Similarly, CRM2 connects to schema S2, which may include the CONTACTS_TBL table illustrated in FIG. 2. CRM2 is in data communication with one or more client computer systems 76 via the WAN. CRM2 is configured to receive transactions from client computer system 76. These transactions may include requests that initiate access of one or more tables of schema S2 in order to, for example, insert a new record with values entered by a user into an interface implemented on client 76. FIG. 3 graphically illustrates a portion of one user interface 78, which includes several of fields for entering contact data and a submit button. The example array user interface 78 may be used to initiate the creation of a new record within CONTACTS_TBL of FIG. 2.

Schemas S1 and S2 include corresponding tables such as the CONTACTS_TBL tables. CRM1 and CRM2 employ different business rules for inserting new records or updating existing records within corresponding tables of schemas S1 and S2, respectively. The differences in schemas S1 and S2, however, preclude interoperability with CRM2 and CRM1, respectively. However, since CRM1 and CRM 2 connect to their own database schemas, CRM1 and CRM2 can run concurrently until all users of the old version CRM1 are migrated to CRM2. However, it is important to synchronize data within corresponding tables such as the CONTACTS_TBL tables while users are migrating. Data synchronization between tables is implemented in the system 10 via a replicator 42 implemented on a computer system (e.g., server) 40.

In one embodiment, replicator 42 may take form in one or more instructions executing on one or more processors of server 40. Replicator 42 implements a process to synchronize corresponding tables within schemas S1 and S2. To illustrate, when CRM1 inserts a new record into S1's CONTACTS_TBL, replicator 42 initiates the insertion of a corresponding new record in S2's CONTACTS_TBL via DBM 74. Likewise, when CRM2 inserts a new record into S2's CONTACTS_TBL, replicator 42 initiates the insertion of a corresponding new record in S1's CONTACTS_TBL via DBM 34. Moreover when CRM1 updates an existing record in a table of S1, replicator updates a corresponding record in S2 via DBM 74, and when CRM2 updates an existing record in a table of S2, replicator 42 updates a corresponding record in S1 via DBM 34.

Replicator 42 is capable of processing record data during synchronization to accommodate differences in corresponding table definitions. For example, when record 0-3 was inserted into S1's CONTACTS_TBL, replicator 42 responded by separating the value within the Phone_Number field into an area code and base seven digit phone number, which in turn were added to the Area_Code and Phone_Number fields of the CONTACTS_TBL table as shown in FIG. 2. Likewise when record 0-1 was inserted into the S2's CONTACTS_TBL table, replicator 42 responded by combining the values of the Area_Code and Phone_Number fields to create the ten digit number within the Phone_Number field of record 0-1 in S1's CONTACTS_TBL.

Because corresponding tables, such as the CONTACTS_TBL tables shown in the figures, are synchronized in the system 10 shown in FIG. 1, different versions of CRM1 and CRM2 can run concurrently until all users of CRM1 have been migrated to CRM2. However, the system shown in FIG. 1 requires the added costs of separate database systems 24 and 64 to concurrently implement schemas S1 and S2, respectively, in addition to a replicator 42 for synchronizing corresponding tables in S1 and S2.

Using an alternative embodiment, a business can concurrently run separate versions of a CRM application during an upgrade process, without the added costs of separate database systems. In this alternative embodiment, the old and new versions of CRM can run concurrently against the same database system. Moreover this alternative embodiment does not require use of a replication server during application upgrade. This alternative embodiment may involve sharing of database objects (e.g., tables) in a database system as will be more fully described below.

To be shared by CRM versions, an existing table defined within old schema S1 can be modified by adding one or more new columns. In general, the one or more new columns are configured to accommodate one or more business rules specific to the new CRM application. New columns added to an existing table of S1 should have names that are different than the names of the existing columns within the table. The added columns will not disrupt operation of the old CRM application; the old CRM application will continue to connect to the modified table using the original schema owner S1. Each modified table remains an object of the S1 schema, but can be accessible by the new CRM through a view or the combination of a view and synonym, which complies with the schema definitions of the CRM. Adding the new columns to the table and creating a view enables the table of S1 to be shared between the old and new CRMs.

A new schema S2N is also defined for the new CRM application, which contains data objects (e.g., tables) that are configured to accommodate specific business rules of the new CRM application. The new schema S2N should also include one or more views through which the new CRM can access (e.g., select, insert, update, etc.) the shared tables of the S1 schema. The one or more views provide a virtual layer between schema S1 and the new CRM application.

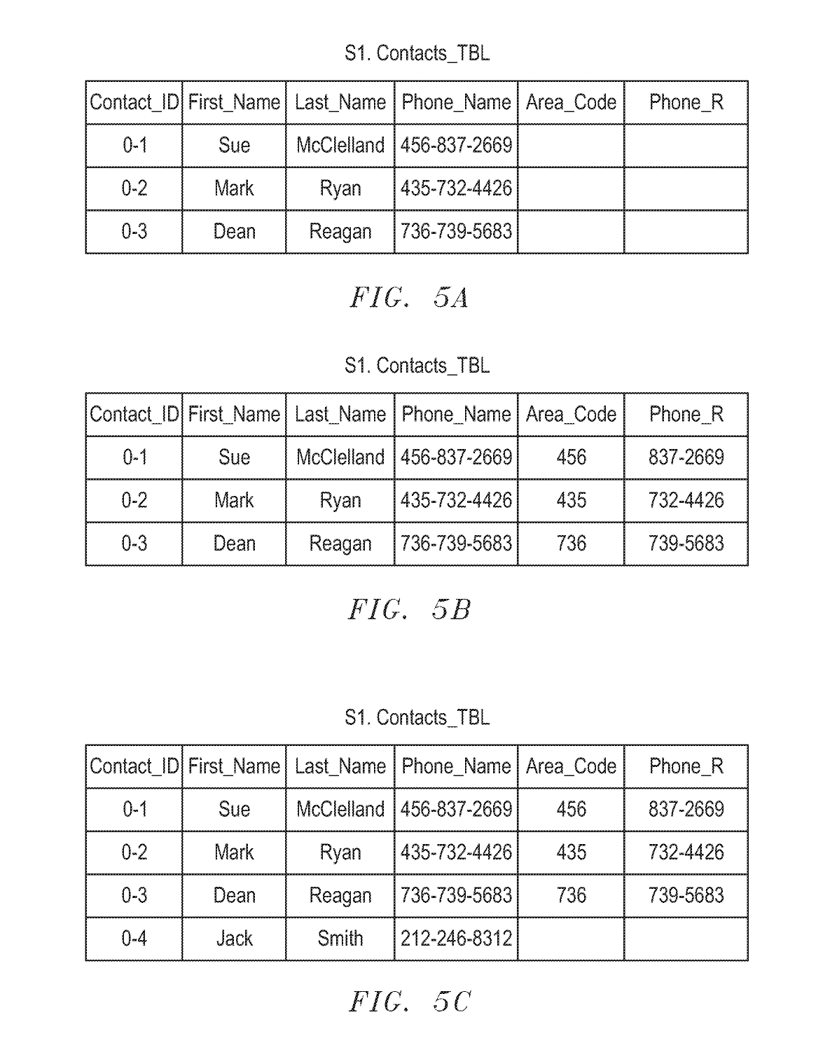

FIG. 4 illustrates in block diagram form, relevant components of a system 100 that enables concurrent running of different versions of a CRM application in accordance with one embodiment of the alternative approach to upgrading CRM applications. FIG. 4 will be described with reference to the same CRM applications (i.e., CRM1 and CRM2) and much of the same database system 24 shown in FIG. 3 and described above.

Like the system shown in FIG. 3, CRM1 and CRM2 in FIG. 4 are implemented on application servers 20 and 60. In other embodiments, CRM1 and CRM2 may be implemented on the same application server. Unlike the system shown in FIG. 3, both application servers 20 and 60 are in data communication with a single database system (i.e., database system 24) via communication link 26.

Like the system shown in FIG. 3, database system 24 includes database server 28, which implements DBM 34. Unlike the system shown in FIG. 3, database system 24 includes triggers that can synchronize columns of shared tables as will be more fully described below. A database trigger is procedural code that is automatically executed in response to certain events on a particular table or view. There are typically three triggering events that cause triggers to ‘fire’: inserting a new record; updating an existing record, or; a deleting an existing record. No synchronization should be done for version specific data objects such as EIM (interface) tables, repository (metadata) tables, and some other working or server configuration tables.

DBM 34 is in data communication with a storage subsystem 30 via communication link 32. Storage subsystem 30 stores database objects of schemas S1 and S2N including the aforementioned virtual layer. CRM1 and CRM2 are in data communication with clients 36 and 78 via the WAN. CRM1 and CRM2 are capable of connecting to data objects of schema S1 and schema S2N, respectively, using distinct schema owner qualifiers, which makes CRM1 and CRM2 unaware of each other even though they are sharing the same database system 24. While connected, CRM1 and CRM2 can generate SQL statements in response to receiving transactions from client computer systems 36 and 78, respectively. The SQL statements are transmitted to DBM 34 via communication link 26 and the respective connections. DBM 34 is configured to implement the SQL statements received from CRM1 and CRM2. Implementation of these SQL statements may result in inserting new records, updating existing records, or deleting records in tables of schemas S1 and S2N.

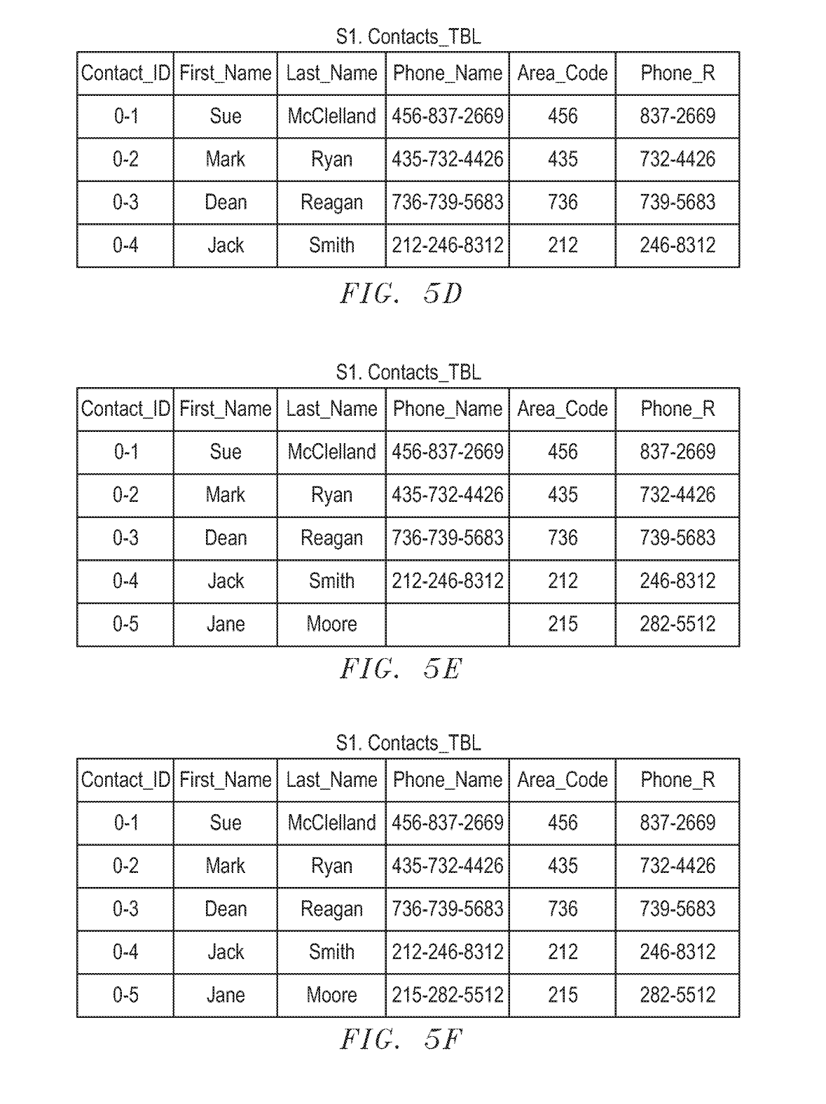

Before CRM1 and CRM2 run concurrently, shared tables are created by adding columns to one or more tables of schema S1. To illustrate by way of example, FIG. 5A illustrates the CONTACTS_TBL table of FIG. 1 after new columns Area_Code and Phone_R are added thereto in accordance with one embodiment of the invention. Initially, new columns Area_Code and Phone_R are empty, but they can be populated by an initial column synchronization (ICS) process executing on database server 28. For each record of the CONTACTS_TBL table shown in FIG. 5A, the ICS process, acting in concert with DBM 34, selects data from the Phone_Number field, processes the selected data by separating the first three digits from the remaining seven digits, and inserts the separated three digits and seven digits into the Area_Code and Phone_R fields, respectively. FIG. 5B illustrates the common table of FIG. 5A after the Area_Code and Phone_R fields are populated. Separate initial synchronization processes can be employed for other shared tables of schema S1. It is noted that separate ICS processes may include processing more sophisticated than simply separating existing values of record fields.

Schema S2N is also created, which should include database objects (e.g., tables) specific to CRM2 in addition to a virtual layer that consists of one or more views and/or synonyms through which CRM2 can access shared tables (e.g., S1.CONTACT_TBL). For example a view S2N_CONTACT.TBLcan be created through which CRM2 can access the CONTACT.TBL table shown in FIG. 5B. This view can be created, for example, with the following SQL statement:

CREATE VIEW S2N.CONTACT_TBL AS
SELECT Contact_ID, First_Name, Last_Name, Area_Code,
Phone_R AS Phone_Number FROM S1.CONTACT_TBL;

After creation of schema S2N and the shared database tables (e.g., CONTACT.TBL of FIG. 5B), CRM 1 and CRM 2 can run concurrently on servers 20 and 60, respectively, of FIG. 4. To illustrate, assume a user of client 36 activates the “Submit” button displayed on user interface 38 after the user enters the values into the various fields as shown therein. CRM1 receives a transaction from client 36, which includes the user-entered field values, and uses its business rules to map the user-entered field values to fields of the CONTACTS_TBL table of schema S1. CRM1 then generates an insert statement using the S1 schema definition for CONTACTS_TBL, and the insert statement is subsequently transmitted to DBM 34 for implementation. FIG. 5C illustrates the table of FIG. 5B after DBM 34 implements the insert statement, which includes the insertion of record 0-4.

A forward database trigger is fired by the insertion of record 0-4 or by DBM receipt of the insert statement from CRM1. This forward trigger may take form in instructions executing on one or more processors of server 28. The forward trigger operates to synchronize the Area_Code and Phone_R fields with the Phone_Number field of a newly inserted record. The forward trigger, in one embodiment, may retrieve the ten digit phone number and subsequently separate the ten digit phone number into an area code and base phone number. This process may include the generation of an update statement to update the Area_Code and Phone_R fields of newly inserted record 0-4 with the area code and base phone numbers, respectively, produced by the forward trigger. FIG. 5D illustrates the table shown in FIG. 5C after the forward trigger completes its operation. Although not shown in the figures, additional forward triggers may be available to forward synchronize other shared tables.

CRM2 can access the CONTACTS_TBL table shown in FIG. 5D at any time through the view S2N.CONTACTS_TBLCRM2. For example, CRM2 can generate a SQL statement that retrieves the Phone_R field value from records of S1.CONTACTS_TBL through the view as Phone_Number. To further illustrate, assume a user of client 76 activates the “Submit” button displayed on user interface 78 after the user enters the values into the various fields as shown in FIG. 4. CRM2 receives a transaction from client 76, which includes the user-entered field values, and CRM2 can use its business rules to map the user-entered field values to record fields of view S2N.CONTACTS_TBL. CRM2 can then generate an insert statement using the view definition, and the insert statement is subsequently transmitted to DBM 34 for implementation. FIG. 5E illustrates the table of FIG. 5D after DBM 34 implements the insert statement via view S2N.CONTACTS_TBL, which includes the insertion of record 0-5. In cases when both versions of the CRM application attempt a simultaneous update of the same record in the database, concurrency is controlled by DBM 34.

A backward database trigger on database server 28 can be fired in response to the insertion of record 0-5 into S1.CONTACTS_TBL or by DBM 34's receipt of the insert instruction from CRM2. This backward trigger may take form in instructions executing on one or more processors of server 28. The backward trigger operates to synchronize the Area_Code and Phone_R fields with the Phone_Number field of a newly inserted record. The backward trigger, in one embodiment, may retrieve the area code and base phone number from the Area_Code and Phone_R fields of the newly inserted record, and subsequently combines the two values to create a ten digit phone number. This process may also include the generation of an update statement to update the Phone_Number field of record 0-5 with the newly created ten digit number. FIG. 5F illustrates the table shown in FIG. 5E after the backward trigger completes its operation. CRM1 can access the CONTACTS_TBL table shown in FIG. 5F. For example, CRM1 can generate a SQL statement that retrieves the Phone_Number field value from record 0-5 for subsequent display in a field of a user interface on client 36. Although not shown in the figures, additional backward triggers may be available to forward synchronize other shared tables. The insert statements generated by both CRMs in the example would include the same table name CONTACTS_TBL and the same field name Phone_Number.

The ultimate goal is to complete migration of all users from the old version of the CRM application to the new version over an extended period of time. Upon completion of user migration, the old version of the application can be retired. The database schemas S1 and S2N can be merged into a single schema owner, and version specific objects associated with S1 can be deleted. In one embodiment, merger may include changing schema ownership of shared tables from S1 to S2N and deleting the virtual layer of S2N. Merger may also include deleting columns in shared tables that are exclusive to the old CRM, and renaming columns in the shared table to accommodate deletion of the virtual layer. For example, the Phone_Number column, which is exclusive to CRM 20, may be deleted in the table of FIG. 5F, and the Phone_R column may be renamed to Phone_Number.

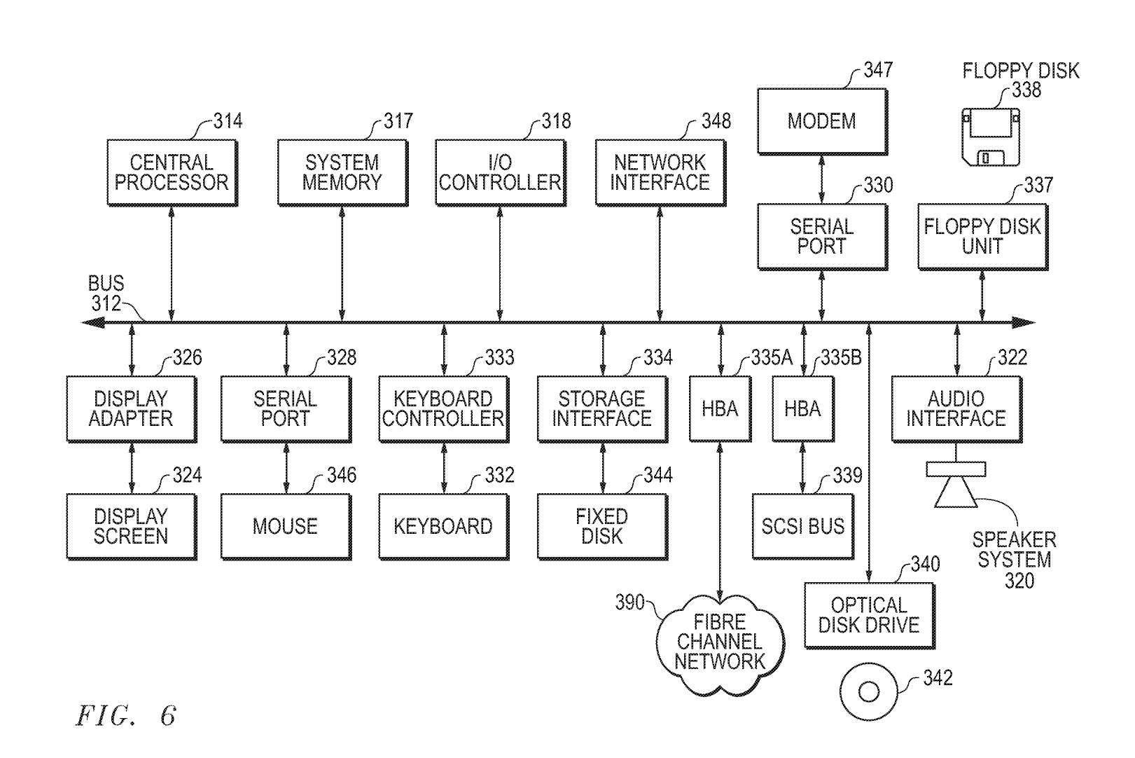

FIG. 6 depicts a block diagram of a computer system 310 suitable for implementing the present disclosure. Computer system 310 may be illustrative of various computer systems (e.g., servers or clients) shown in FIGS. 3 and 4. Computer system 310 includes a bus 312 which interconnects major subsystems of computer system 310, such as a central processor 314, a system memory 317 (typically RAM, but which may also include ROM, flash RAM, or the like), an input/output controller 318, an external audio device, such as a speaker system 320 via an audio output interface 322, an external device, such as a display screen 324 via display adapter 326, serial ports 328 and 330, a keyboard 332 (interfaced with a keyboard controller 333), a storage interface 334, a floppy disk drive 337 operative to receive a floppy disk 338, a host bus adapter (HBA) interface card 335A operative to connect with a Fibre Channel network 390, a host bus adapter (HBA) interface card 335B operative to connect to a SCSI bus 339, and an optical disk drive 340 operative to receive an optical disk 342. Also included are a mouse 346 (or other point-and-click device, coupled to bus 312 via serial port 328), a modem 347 (coupled to bus 312 via serial port 330), and a network interface 348 (coupled directly to bus 312).

Bus 312 allows data communication between central processor 314 and system memory 317, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 310 are generally stored on and accessed via a computer readable medium, such as a hard disk drive (e.g., fixed disk 344), an optical drive (e.g., optical drive 340), a floppy disk unit 337, or other storage medium. Additionally, applications can be in the form of electronic signals modulated in accordance with the application and data communication technology when accessed via network modem 347 or interface 348.

Storage interface 334, as with the other storage interfaces of computer system 310, can connect to a standard computer readable medium for storage and/or retrieval of information, such as a fixed disk drive 344. Fixed disk drive 344 may be a part of computer system 310 or may be separate and accessed through other interface systems. Modem 347 may provide a direct connection to a remote server via a telephone link or to the Internet via an internet service provider (ISP). Network interface 348 may provide a direct connection to a remote server via a direct network link to the Internet via a POP (point of presence). Network interface 348 may provide such connection using wireless techniques, including digital cellular telephone connection, Cellular Digital Packet Data (CDPD) connection, digital satellite data connection or the like.

The operation of a computer system such as that shown in FIG. 6 is readily known in the art and is not discussed in detail in this application. Code for inserting new records into shared tables, synchronizing fields in records of shared tables, etc., to implement the present disclosure can be stored in computer-readable storage media such as one or more of system memory 317, fixed disk 344, optical disk 342, or floppy disk 338. Memory 320 is also used for storing temporary variables or other intermediate information during the execution of instructions by the processor 310. The operating system provided on computer system 310 may be MS-DOS®, MS-WINDOWSO, OS/2®, UNIX®, Linux®, or another known operating system.

Although the invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

We claim:

1. A method comprising:
a first version of an application generating a first SQL insert statement, wherein the first SQL insert statement comprises a first table name, a first field name, and a first value;
a second version of an application generating a second SQL insert statement, wherein the second SQL insert statement comprises the first table name, the first field name, and a second value;
a database system inserting a first record into a first table in response to the database system receiving the first SQL insert statement;
the database system inserting a second record into the first table via a view in response to the database system receiving the second SQL insert statement;
wherein the first record comprises distinct first and second fields corresponding to the first name and a second field name, respectively, and wherein the first field stores the first value;
wherein the second record comprises distinct first and second fields corresponding to the first and second field names, respectively, and wherein the second field of the second record stores the second value.

2. The method of claim 1 further comprising:
the database system generating a first result as a function of processing the first value;
the database system storing the first result in the second field of the first record.

3. The method of claim 2 further comprising:
the database system generating a second result as a function of processing the second value;
the database system storing the second result in the first field of the second record.

4. A method comprising:
a first application generating a first SQL statement for modifying a physical table of a first database;
modifying the physical table in response to the generation of the first SQL statement;
a second application generating a second SQL statement for modifying a logical table of a second database schema, which is distinct from the first database schema;
modifying the physical table in response to the generation of the second SQL statement.

5. The method of claim 4 wherein the second application comprises business rules that are different from the business rules of the first application.

6. The method of claim 5 wherein the first and second applications are executing on one or separate computers systems when the first and second SQL statements are generated.

7. The method of claim 4 further comprising the second application generating a third SQL statement for modifying a physical table of the second database schema, wherein the third SQL statement comprises a name of the physical table of the second database schema, wherein the first SQL statement comprises a name of the physical table of the first database schema, and wherein the second statement comprises a name of the logical table of the second database schema.

8. The method of claim 4 wherein the logical table comprises a view that that contains one or more columns from the physical table of the first database schema.

9. The method of claim 4:
wherein modifying the physical table in response to the generation of the first SQL statement comprises an act of updating a first value in a first field of a first record in the physical table;
wherein modifying the physical table in response to the generation of the second SQL statement comprises an act of updating a second value in a second field of a second record in the physical table.

10. The method of claim 9 further comprising:
a first database trigger processing the first value to generate a third value;
updating a second field of the first record with the third value;
a second database trigger processing the second value to generate a fourth value;
updating a first field of the second record with the fourth value.

11. The method of claim 4:
wherein modifying the physical table in response to the generation of the first SQL statement comprises an act of inserting a first record, wherein the first record comprises a first value in a first field;
wherein modifying the physical table in response to the generation of the second SQL statement comprises an act of inserting a second record, wherein the second record comprises a second value in a second field.

12. The method of claim 11 further comprising:
a first database trigger processing the first value to generate a third value;
updating a second field of the first record with the third value;
a second database trigger processing the second value to generate a fourth value;
updating a first field of the second record with the fourth value.

13. A computer readable medium comprising instructions, wherein a computer system implements a method in response to executing the instructions, the method comprising:
receiving a first SQL statement for modifying a physical table of a first database;
modifying the physical table in response to receiving the first SQL statement;
receiving a second SQL statement for modifying a logical table of a second database schema, which is distinct from the first database schema;
modifying the physical table in response to receiving the second SQL statement.

14. The computer readable medium of claim 13 wherein the logical table comprises a view that that contains one or more columns from the physical table of the first database schema.

15. The computer readable medium of claim 13:
wherein modifying the physical table in response to the generation of the first SQL statement comprises an act of updating a first value in a first field of a first record in the physical table;
wherein modifying the physical table in response to the generation of the second SQL statement comprises an act of updating a second value in a second field of a second record in the physical table.

16. The computer readable medium of claim 15 wherein the method further comprises:
processing the first value to generate a third value;
updating a second field of the first record with the third value;
processing the second value to generate a fourth value;
updating a first field of the second record with the fourth value.

17. The computer readable medium of claim 13:
wherein modifying the physical table in response to the generation of the first SQL statement comprises an act of inserting a first record, wherein the first record comprises a first value in a first field;
wherein modifying the physical table in response to the generation of the second SQL statement comprises an act of inserting a second record, wherein the second record comprises a second value in a second field.

18. The computer readable medium of claim 17 wherein the method further comprises:
a first database trigger processing the first value to generate a third value;
updating a second field of the first record with the third value;
a second database trigger processing the second value to generate a fourth value;
updating a first field of the second record with the fourth value.

19. The computer readable medium of claim 13 wherein the first and second SQL statements are received from first and second applications, respectively, which are executing on one or separate computers systems when the first and second SQL statements are received, wherein the second application comprises business rules that are different from the business rules of the first application.

20. An apparatus comprising:
a first circuit for receiving first and second SQL statements, wherein the first SQL statement is configured for modifying a physical table of a first database, and wherein the second SQL statement is configured for modifying a logical table of a second database schema, which is distinct from the first database schema;
a second circuit for modifying the physical table in response to the first SQL statement, and for modifying the physical table in response to receiving the second SQL statement.

21. A method comprising a first computer system transmitting instructions to a second computer system for storage in a memory thereof, wherein the second computer system implements a method in response to executing the instructions, the method comprising:
receiving a first SQL statement for modifying a physical table of a first database;
modifying the physical table in response to receiving the first SQL statement;
receiving a second SQL statement for modifying a logical table of a second database schema, which is distinct from the first database schema;
modifying the physical table in response to receiving the second SQL statement.
